(19) United States
(12) Patent Application Publication
(10) Pub. No.: US 2026/0256335 A1
(43) Pub. Date: Sep. 3, 2026

(54) MULTI-LAYER WIPING CLOTH

(71) Applicant: HUBEI LIERJIA COMMODITY CO., LTD., Xianning, Hubei (CN)

(72) Inventor: Yaowen LI, Xianning, Hubei (CN)

(21) Appl. No.: 18/878,596

(22) PCT Filed: Aug. 27, 2024
(86) PCT No.: PCT/CN2024/114675

§ 371 Date: Dec. 23, 2024

(30) Foreign Application Priority Data
Sep. 8, 2023 (CN) 202322438543.9

(51) Int. Cl. A47L 13/16

(52) U.S. Cl. CPC A47L 13/16

(57) ABSTRACT

A multi-layer wiping cloth, comprising multiple layers of first wiping units, each first wiping unit is stacked in sequence, two adjacent first wiping units are detachably connected; each of the first wiping units comprises a first base layer and a first hydrophilic paste laid on the first base layer. In the invention, the first wiping units adopt a multi-layer detachable structure and utilize first hydrophilic paste; this not only improves the water absorption of the wiping cloth, ensuring a better cleaning effect, but also peels off surface layer of the first wiping unit after wear or heavy soiling, and uses a new first wiping unit to continue cleaning, greatly extending the service life of the wiping cloth.

### 1. TECHNICAL FIELD

The invention relates to the technical field of cleaning tools, in particular to a multi-layer wiping cloth.

### 2. BACKGROUND ART

The cleaning cloths currently used in the market are typically made of towel fabric, which have poor water absorption, leading to ineffective wiping; additionally, since they are all single-layer structures, they need to be replaced more frequently when they wear out or become heavily soiled.

### 3. SUMMARY OF THE INVENTION

The invention aims to overcome the defects of the prior art and provides a multi-layer wiping cloth to solve the technical problems.

The object of the invention is achieved in the following way:
a multi-layer wiping cloth, comprising multiple layers of first wiping units, each first wiping unit is stacked in sequence, two adjacent first wiping units are adhered to each other, each of the first wiping units comprises a first base layer and a first hydrophilic paste laid on the first base layer.

Further, two adjacent layers of the first wiping units are bonded.

Further, the first hydrophilic paste is laid on both sides of the first base layer.

Further, the first base layer is made of fiber cloth or non-woven fabric,

Further, the multi-layer wiping cloth further comprises a plurality of second wiping units, each layer of the second wiping units is sequentially superimposed on the outer first wiping unit, two adjacent layers of the second wiping units are detachably connected, each of the second wiping units comprises a second base layer and a second hydrophilic paste laid on the second base layer.

Further, the multi-layer wiping cloth further comprises an annular outer frame, and each layer of the first wiping units can be detachably installed in the outer frame; the outer frame is a telescopic structure, and the telescopic direction is the thickness direction of the first wiping unit.

Further, the multi-layer wiping cloth further comprises a bottom plate, the bottom plate and the outer frame are enclosed to form a box with an opening, each of the first wiping units is detachably installed in the box through the opening, and at least parts of first wiping units are located outside the box.

Further, the handheld rods are installed on an outer side of the bottom plate, and the handheld rods are rotatably connected to the bottom plate.

Further, the multi-layer wiping cloth further comprises a base, each of the first wiping units is sequentially overlapped on the base.

Further, the multi-layer wiping cloth comprises comprising 6-30 layers of first wiping units, and the thickness of each first wiping unit is 0.8-2 mm.

Compared with the prior art, the invention has the following advantageous technical effects:
the multi-layer wiping cloth provided by the invention is provided with multiple layers of first wiping units, the first wiping units are detachably connected to each other. As a result, when the surface layer of the first wiping unit becomes worn or heavily soiled, it can be directly detached, exposing the first wiping unit in the inner laye; on the other hand, the multiple layers of first wiping units provide stronger water absorption, and the use of the first hydrophilic paste further ensures the wiping effectiveness due to the good hydrophilic properties.

### 4. BRIEF DESCRIPTION OF ACCOMPANY DRAWINGS

FIG. 1 is a schematic diagram of the structure of the multi-layer wiping cloth provided by the embodiment of the invention from the first perspective.

FIG. 2 is a schematic diagram of the structure of the multi-layer wiping cloth provided by the embodiment of the invention from the second perspective.

FIG. 3 is a schematic diagram of the structures of the first wiping units and the second wiping units of the multi-layer wiping cloth provided in the embodiment of the invention.

FIG. 4 is a schematic diagram of the structure of the box in the multi-layer wiping cloth provided in the embodiment of the invention.

FIG. 5 is a schematic diagram of the structure where the first wiping units of the multi-layer wiping cloth provided in the embodiment of the invention is located on the base.

### 5. SPECIFIC EMBODIMENT OF THE INVENTION

The technical schemes in the embodiments of the invention will be clearly and completely described in combination with the accompanying drawings in the embodiments of the invention. Obviously, the described embodiments are only some of the embodiments of the invention, but not all of the embodiments. Based on the embodiments in this invention, all other embodiments obtained by those of ordinary skill in the art without making creative efforts shall fall within the protection scope of this invention.

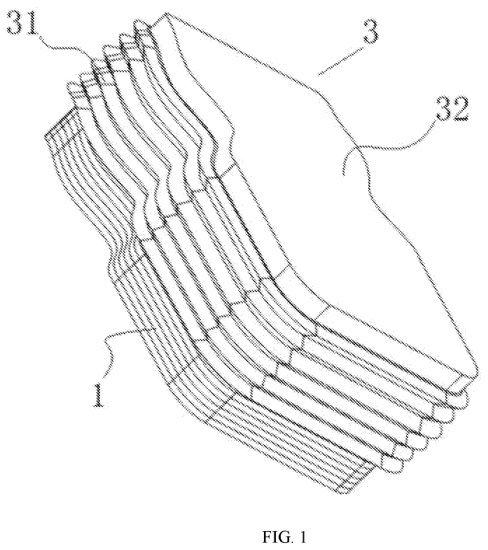

Please refer to FIG. 1 and FIG. 3, the embodiment of the invention provides a multi-layer wiping cloth, primarily used as a cleaning tool, comprising multiple layers of first wiping units 1. Each of first wiping units 1 has a sheet-like structure; during preparation, the first wiping units 1 are stacked in sequence, specifically along the thickness direction of each corresponding first wiping unit 1, and the adjacent first wiping units 1 are detachably connected. In the preferred scheme, the detachable connection between the first wiping units 1 is achieved through adhesion, allowing them to be peeled apart by hand; the structure of the first wiping unit 1 can be further refined, each of the first wiping units comprises a first base layer and a first hydrophilic paste, the first hydrophilic paste can be polyvinyl formal paste, PU (polyurethane) paste, wood pulp, or a mixture of two or more of the aforementioned pastes. The first hydrophilic paste is laid to the surface of the first base layer; during the actual operation, the first hydrophilic paste can be laid on the first base layer by application, with a portion of the first hydrophilic paste penetrating into the first base layer, after cooling, a thin layer structure forms on the surface of the first base layer; alternatively, an immersion method can be used, where the first base layer is placed into the first hydrophilic paste, then both surfaces of the first base layer will be provided with the first hydrophilic paste. In this embodiment, the wiping cloth has multiple layers of the first wiping units 1. Due to the multi-layer structure, the overall thickness is increased, and by utilizing the hydrophilicity of polyvinyl formal, the wiping cloth has excellent water absorption capability, which in turn enhances its cleaning performance. On the other hand, since two adjacent first wiping units 1 are detachably connected, when the first wiping unit 1 on the surface layer becomes significantly worn or heavily soiled due to repeated use, the connection between the surface and the inner layers of the first wiping unit 1 can be disengaged; if the connection is adhesive, the worn or soiled first wiping unit 1 can be easily peeled off by hand, effectively ensuring the wiping cloth's service life.

Referring to FIG. 3, in the specific embodiment, the first base layer can be made of fiber cloth or non-woven fabric; when the first hydrophilic paste is laid on the first base layer, the first hydrophilic paste can penetrate into the first base layer; as a result, when the two layers of the first wiping units 1 are peeled apart, the first hydrophilic paste on the surface of the inner first wiping unit 1 will not easily detach. In the preferred embodiment, each first wiping unit 1 is provided with a handheld portion 11 for convenient gripping; the so-called handheld portion 11 may not necessarily be an additional structure attached to the first wiping unit 1; for instance, when the first wiping unit 1 is elongated, two opposite edges (typically the longer edges) can be provided with concave curved surfaces. In the preferred scheme, the two long edges adopt a symmetrical design, with the concave areas located at the central positions of the corresponding edges; this results in a relatively narrow width dimension at these positions, facilitating the user's grip on the wiping cloth. Alternatively, if both long edges are entirely concave curved surfaces, the central position corresponds to the apex of the concave curves, ensuring a similarly narrow width dimension at the center.

Referring to FIG. 3 again, in an embodiment, the multi-layer wiping cloth further comprises multiple layers of second wiping units 2, each of second wiping units 2 adopts a structure similar to the first wiping unit 1. Each layer of the second wiping units 2 is sequentially superimposed on the outer first wiping unit 1, two adjacent layers of the second wiping units 2 are detachably connected, of course, the detachable connection between the two can also be bonded, so that when the second wiping units 2 are used for cleaning, if the outer second wiping unit 2 is severely worn, the outer second wiping unit 2 can be peeled off. The second wiping units 2 and the first wiping units 1 are made of two different materials. Each second wiping unit 2 specifically comprises a second base layer and a second hydrophilic paste laid on the second base layer; the second base layer can also be made of fiber cloth or non-woven fabric; then the second hydrophilic paste is applied, etc., and the second hydrophilic paste can also adopt polyvinyl formal paste, PU (polyurethane) paste, wood pulp, etc. ; however, when the first hydrophilic paste is polyvinyl formal paste, the second hydrophilic paste should be PU paste or wood pulp. Based on this embodiment, the wiping cloth is divided into two parts: one part is multiple layers of first wiping units 1, and the other part is multiple layers of second wiping units 2. The user can flexibly choose the appropriate side for wiping and cleaning according to actual cleaning needs, ensuring effective cleaning performance. Furthermore, the innermost first wiping unit 1 and second wiping unit 2, being adjacent to each other, can be detachably connected, such as by adhesive bonding, or fixedly connected, without affecting the normal use of each first wiping unit 1 and second wiping unit 2. Typically, the thickness of a single layer of the first wiping unit 1 or the second wiping unit 2 is between 0.8 and 2 mm, and there can be 6 to 30 layers, with each layer being usable for cleaning, effectively ensuring the service life.

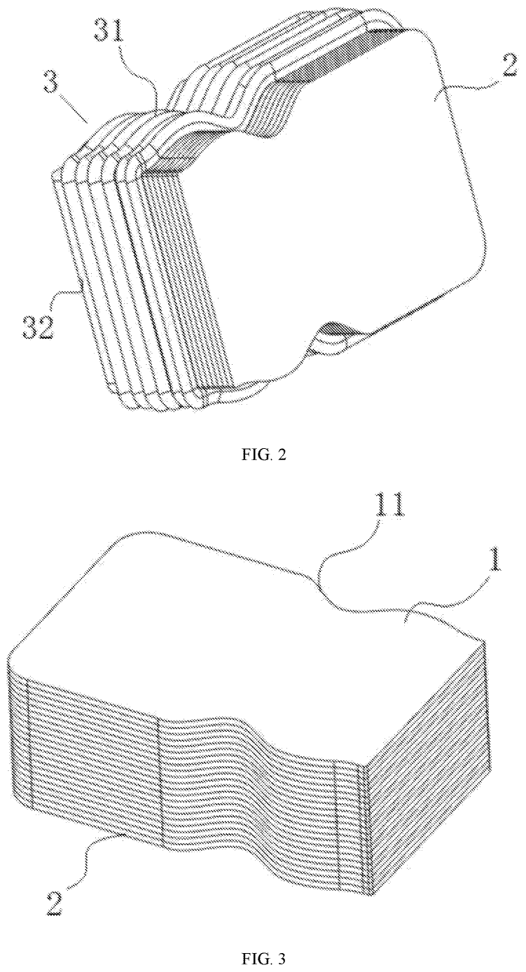

Referring to FIG. 1 and FIG. 2, in a preferred embodiment, the multi-layer wiping cloth further comprises an outer frame 31, the outer frame 31 is annular, and each layer of the first wiping units 1 can be detachably installed in the outer frame 31; when the wiping cloth also comprises the second wiping units 2, the second wiping units 2 are also located in the outer frame 31; the outer frame 31 is a telescopic structure, which is similar to a telescopic tube structure, and can be folded and telescoped along the thickness direction of the first wiping unit 1. In this embodiment, since the first wiping units 1 or the second wiping units 2 become softer to some extent after absorbing water, the setting of the outer frame 31 can play a shaping role. The annular structure of the outer frame 31 is adapted to the shape of the first wiping unit 1; for example, if the first wiping unit 1 is provided with the aforementioned handheld portion 11, the outer frame 31 will also be provided with this handheld portion 11, making it convenient for the user to hold. In actual use, at least parts of the structure of the first wiping units 1 or the second wiping units 2 are located on the outer side of the outer frame 31, ensuring that the cleaning surface of the wiping cloth protrudes outside the outer frame 31, thereby preventing the outer frame 31 from contacting the area to be cleaned. When the first wiping unit 1 or the second wiping unit 2, located on the outer side of the outer frame 31, is peeled off, causing the distance between the outer layer of the first wiping unit 1 or the second wiping unit 2 and the end face of the outer frame 31 relatively small, the outer frame 31 can be compressed in the thickness direction to increase the distance between the outer layer of the first wiping unit 1 or the second wiping unit 2 and the end face of the outer frame 31, thereby prevent the outer frame 31 from interfering with the cleaning processs. Additionally, both the first wiping units 1 and the second wiping units 2 can be detachably mounted inside the outer frame 31, typically through a snap-fit design, allowing the first or second wiping units to be pulled out of the outer frame 31 as a whole.

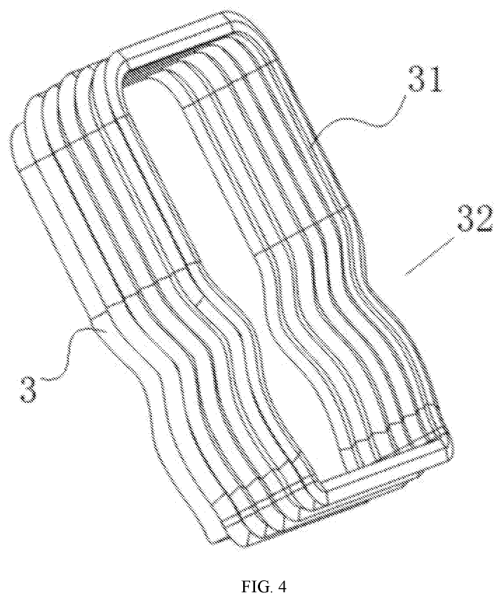

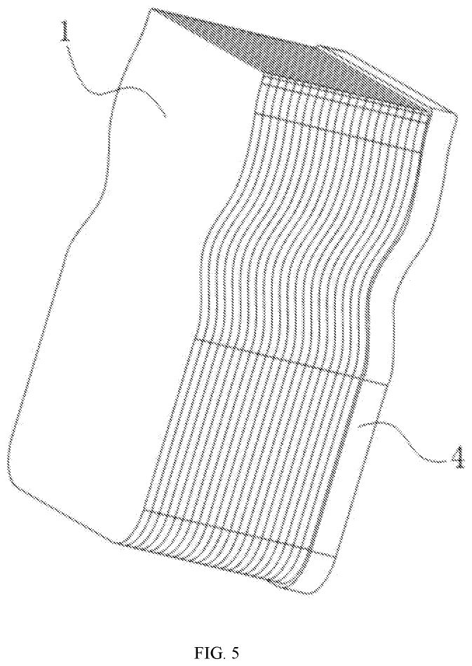

Referring to FIG. 1, FIG. 2 and FIG. 4, the above embodiment is further optimized. The multi-layer wiping cloth further comprises a bottom plate 32, the bottom plate 32 and the outer frame 31 are enclosed to form a box 3 with an opening, each first wiping unit 1 and each second wiping unit 2 are detachably installed in the box 3 through the opening, and at least parts of first wiping units 1 or second wiping units 2 are located outside the box 3. In this embodiment, a bottom plate 32 is set to form the box 3; as a result, some parts of the first wiping units 1 or the second wiping units 2 are located inside the box 3, and other parts is located outside the box 3. When the user uses the wiping cloth, the bottom plate 32 can restrict the movement of the first wiping unit 1 or the second wiping unit 2 in the thickness direction. Additionally, when the wiping cloth includes both the first wiping units 1 and the second wiping units 2, if the first wiping units 1 are used, the second wiping units 2 are located inside the box 3; when the second wiping units 2 are needed, they can be fully pulled out and reinstalled inside the box 3, at which point the second wiping units 2 are on the outside and the first wiping units 1 are on the inside. Several through-holes are arranged on the bottom plate 32 to balance the air pressure inside and outside the box 3, preventing the first wiping unit 1 or the second wiping unit 2 from adhering to the inner surface of the bottom plate 32 after absorbing water.

Further, handheld rods are installed on an outer side of the bottom plate 32, and the handheld rods are rotatably connected to the bottom plate 32, thereby facilitating users to clean high positions. Alternatively, a hanging structure may be arranged on the bottom plate 32, such as through a hanging hole; when not in use, the wiping cloth can be hung on a wall or similar surface. When the wiping cloth does not have the bottom plate 32 and outer frame 31, hanging holes can be set on the first wiping units 1 and second wiping units 2; these hanging holes pass through each layer along the thickness direction, the hanging holes are typically near the end, allowing ropes or similar materials to pass through, making it easier to hang the wiping cloth on a wall or other surface.

Referring to FIG. 3 and FIG. 5, in one embodiment, the multi-layer wiping cloth further comprises a base 4, each of the first wiping units 1 is sequentially overlapped on the base 4. Alternatively, when the wiping cloth comprises both the first wiping units 1 and the second wiping units 2, the front and back sides of the base 4 are respectively provided with the first wiping units 1 and the second wiping units 2, meaning that the base 4 is positioned in the middle. In this embodiment, the base 4 can be made of a rigid material, such as plastic; when there are only a few first wiping units 1 or second wiping units 2, the base 4 can also be easily held by the user; additionally, when this structure is placed inside a box 3, if there are only a few first wiping units 1 or second wiping units 2, the base 4 can ensure that the first wiping units 1 or the second wiping units 2 protrude from the box 3.

The above description is only preferred embodiments of the invention and is not intended to limit the invention. Any modification, equivalent replacement, improvement, etc. made within the spirit and principle of the invention shall be included in the protection scope of the invention.

What is claimed is:

1. A multi-layer wiping cloth, comprising multiple layers of first wiping units, each first wiping unit is stacked in sequence, two adjacent first wiping units are adhered to each other, and the first wiping units can be peeled off by applying external force;
each of the first wiping units comprises a first base layer and a first hydrophilic paste, and the first hydrophilic paste is laid on both sides of the first base layer;
the first base layer is made of fiber cloth or non-woven fabric, and the first hydrophilic paste penetrates into the first base layer, when the two layers of the first wiping units are peeled off, the first hydrophilic paste on inner surfaces of the first wiping units will not easily fall off.

2. The multi-layer wiping cloth of claim 1, wherein the first hydrophilic paste forms a thin layer structure on the surface of the first base layer.

3. The multi-layer wiping cloth of claim 1, wherein the first hydrophilic paste comprises polyvinyl formal paste.

4. The multi-layer wiping cloth of claim 3, wherein the polyvinyl formal paste partially penetrates into the fiber cloth or non-woven fabric, and forms the thin layer structure on the surface of the first base layer after cooling.

5. The multi-layer wiping cloth of claim 1, comprising 6-30 layers of first wiping units, and the thickness of each first wiping unit is 0.8-2 mm.

6. The multi-layer wiping cloth of claim 1, further comprising a plurality of second wiping units, each layer of the second wiping units is sequentially superimposed on the outer first wiping unit, two adjacent layers of the second wiping units are detachably connected, each of the second wiping units comprises a second base layer and a second hydrophilic paste laid on the second base layer.

7. The multi-layer wiping cloth of claim 1, further comprising an annular outer frame, and each layer of the first wiping units can be detachably installed in the outer frame; the outer frame is a telescopic structure, and the telescopic direction is the thickness direction of the first wiping unit.

8. The multi-layer wiping cloth of claim 7, further comprising a bottom plate, the bottom plate and the outer frame are enclosed to form a box with an opening, each of the first wiping units is detachably installed in the box through the opening, and at least parts of first wiping units are located outside the box.

9. The multi-layer wiping cloth of claim 8, wherein handheld rods are installed on an outer side of the bottom plate, and the handheld rods are rotatably connected to the bottom plate.

10. The multi-layer wiping cloth of claim 1, further comprising a base, each of the first wiping units is sequentially overlapped on the base.
